(19) United States
(12) Patent Application Publication
(10) Pub. No.: US 2006/0191387 A1
(43) Pub. Date: Aug. 31, 2006

(54) Hand-held machine tool for introducing cuts and method of adjusting cut introduction options in a hand-held machine tool

(75) Inventors: Peter Weber, Schorndorf (DE); Eckhard Ruehle, Neckarwestheim (DE)

Correspondence Address: Lipsitz & McAllister, LLC, 755 MAIN STREET, MONROE, CT, 06468, US

(73) Assignee: Flex-Elektrowerkzeuge GmbH, Steinheim/Murr (DE)

(21) Appl. No.: 11/354,565

(22) Filed: Feb. 14, 2006

(30) Foreign Application Priority Data
Feb. 22, 2005 (DE) 10 2005 009 284.5

(51) Int. Cl. B23D 45/16

(52) U.S. Cl. 83/13; 30/377; 30/388

(57) ABSTRACT

In order that a hand-held machine tool for introducing cuts, comprising a drive motor for at least one cutting tool and a contacting device, by which the hand-held machine tool is adapted to contact an object to be machined and is guidable on said object, may be provided that is universally usable, it is proposed that the drive motor is disposed in a lockable pivotable manner relative to the contacting device, wherein at least one pulling position for the pulling introduction of a cut and at least one pushing position for the pushing introduction of a cut is adjustable.

The present disclosure relates to the subject matter disclosed in German application number 10 2005 009 284.5 of Feb. 22, 2005, which is incorporated herein by reference in its entirety and for all purposes.

### BACKGROUND OF THE INVENTION

The invention relates to a hand-held machine tool for introducing cuts, comprising a drive motor for at least one cutting tool and a contacting device, by which the hand-held machine tool is adapted to contact an object to be machined and is guidable on the object.

The invention further relates to a method of adjusting cut introduction options in a hand-held machine tool for introducing cuts.

Hand-held machine tools for introducing cuts are used for example to produce masonry wall slots.

### SUMMARY OF THE INVENTION

In accordance with the invention, a hand-held machine tool is provided which is universally usable.

In accordance with the invention the drive motor is disposed in a lockable pivotable manner relative to the contacting device, wherein at least one pulling position for pulling introduction of a cut and at least one pushing position for pushing introduction of a cut is adjustable.

Hand-held machine tools are known, which are guided by pulling in order for example to produce a slot. Equally, hand-held machine tools are known, which are designed such that they may be used to introduce pushing cuts. Horizontal slots are introducible by pulling usually only with great difficulty and vertical slots are introducible by means of pushing cuts only with difficulty.

In accordance with the invention a hand-held machine tool is provided, with which it is easy to switch over between the option of pulling cut introduction and the option of pushing cut introduction. This switchover is effected by pivoting the drive motor relative to the contacting device.

In accordance with the invention, the introduction of pulling cuts and pushing cuts is allowed, depending on which the user selects. The hand-held machine tool is therefore universally usable. In a single hand-held machine tool the possibility of introducing pulling cuts and pushing cuts is realized.

The hand-held machine tool according to the invention may be of a simple construction; in particular, there is no need to provide for a reversal of the direction of rotation of a tool shaft.

The adjustment with regard to the introduction of pulling cuts or pushing cuts is effected prior to the machining of an object.

In particular, it is advantageous when the contacting device is disposed or formed on a tool protection cap. This allows the corresponding hand-held machine tool to be of a compact construction. It may for example be provided that the tool protection cap and the contacting device are movable relative to one another; in this way it is possible for the at least one cutting tool to be positioned in a protected manner in the tool protection cap and lifted out for machining articles.

It is advantageous when a pivot bearing for the pivotability of the drive motor relative to the contacting device is provided, which has a pivotal axis that is substantially coaxial with an axis of rotation of a tool shaft. The change of position of the drive motor relative to the contacting device therefore does not affect the tool movement, i.e. regardless of whether a pushing position or drawing position is adjusted, the tool drive is not modified.

It is advantageous when the drive motor is supported pivotably on a tool protection cap. A tool protection cap has to be provided in order to protect the operator from the rotating cutting tool. The tool protection cap provides a suitable carrier for a pivot bearing.

It is advantageous when at least one gripping element is disposed or formed on a tool protection cap. At this gripping element an operator may grasp the hand-held machine tool in order to be able to introduce a pulling cut or a pushing cut, depending on the position of the drive motor.

It is in particular provided that associated with the at least one gripping element is electric insulation, which insulates the at least one gripping element electrically from metal regions of the hand-held machine tool. It is therefore possible to guarantee the electric safety of the hand-held machine tool, for example for the eventuality that an electric connection cable is cut through. The electric insulation may be disposed directly on the gripping element or it may be disposed for example between a tool protection cap and the rest of the hand-held machine tool. It is for example also possible for the tool protection cap itself to be manufactured from an electrically insulating material.

In one form of construction, the at least one gripping element is formed by means of a hand contact region on the tool protection cap. This hand contact region is in particular provided with grip protection, such as for example with pimples, to prevent slipping. Preferably, the hand contact region is of such a dimension that the hand of a user does not come into contact with metal regions of the tool protection cap when he grasps the hand contact region.

It is additionally or alternatively possible for the at least one gripping element to be formed by means of a bow-type handle. This projects in particular beyond the tool protection cap. An operator may place one hand around a bow-type handle. It is also possible for a gripping element to be formed by means of an extraction elbow. As an extraction elbow projects beyond a tool protection cap, a construction as a gripping element is possible.

It is advantageous when a distinguished pulling position for the drive motor is lockable. In the distinguished pulling position for the drive motor, a pulling cut may be introduced. For example, for this purpose an operator uses his right hand to grasp a motor housing of the drive motor and his left hand to grasp a gripping element on a tool protection cap and pulls the hand-held machine tool.

It is equally advantageous when a distinguished pushing position for the drive motor is lockable. In the pushing position, an operator for example grasps the drive motor with his left hand and places his right hand on a gripping element on the tool protection cap. He may then push the hand-held machine tool away from him in order to be able to introduce a pushing cut into the object to be machined.

In particular, the distinguished pulling position and the distinguished pushing position are situated apart from one another by a pivotal angle of more than 90°. The angle in said case is smaller than or equal to 180°. (It is advantageous when in the distinguished pulling position and in the distinguished pushing position a motor housing is orientated at an acute angle to a contact surface of the contacting device in order to achieve a greater distance between the operator's hand, which is grasping the motor housing, and the article to be machined; in this case, the pulling position and the pushing position are situated less than 180° apart from one another.)

In particular, for the drive motor a motor housing is provided, which is graspable by the operator. He may then use one hand to hold the hand-held machine tool at the motor housing.

In particular, in a distinguished pulling position for the drive motor a motor housing is positioned at an acute angle to a contact surface of the contacting device. This allows the adjustment of a distance or increased distance between a gripping region of the motor housing and the contact surface and hence, during machining of an object, the object to be machined.

For the same reason, it is advantageous when in a distinguished pushing position for the drive motor a motor housing is positioned at an acute angle to a contact surface of the contacting device.

A pulling position is easily fixable when a first blocking element is provided for supplying a blocking surface for a distinguished pulling position of the drive motor. In particular, the first blocking element has a blocking surface that is inclined relative to a contact surface of the contacting device. By means of the blocking surface a pivoting of the drive motor beyond the pulling position is blockable.

For the same reason, it is advantageous when a second blocking element is provided for supplying a blocking surface for a distinguished pushing position of the drive motor and in particular the second blocking element has a blocking surface that is inclined relative to a contact surface of the contacting device.

Fixing of a pushing position and a pulling position is easily achievable when a slotted disk is provided for securing a specific pivoted position of the drive motor relative to the contacting device. The slotted disk may be a separate disk or it may be integrated into a shaft of a pivot bearing for pivoting of the drive motor relative to the contacting device. The slotted disk is disposed for example in a rotationally fixed manner relative to a gearhead or motor housing.

It is advantageous when the slotted disk has a first slot for defining a distinguished pushing position and a second slot for defining a distinguished pulling position. It is therefore easy to secure these distinguished positions and easy to effect a switchover between these distinguished positions.

In a structurally simple form of construction, a locking element is provided, which is engageable into a slot of the slotted disk to secure a specific pivoted position. The locking element secures the pushing position and/or the pulling position. The securing effect may easily be cancelled by withdrawal of the locking element.

In particular, the locking element is spring-loaded. The locking element may therefore be pressed into a slot in order to fix the corresponding position. By exerting a force counter to the spring action, the corresponding position may be unlocked.

In particular, the slotted disk is disposed between the drive motor and a tool protection cap. In the region between the drive motor and in particular between a motor housing of the drive motor and the tool protection cap the appropriate space is provided, in which the slotted disk and the locking element may be positioned.

It is advantageous when a removal device for machining waste is provided. This is connectable for example to a vacuum cleaner. In this way, dust pollution of the environment may be reduced.

It is advantageous when the contacting device has a recess surrounded by a border or enclosure for the at least one cutting tool. The cutting tool may engage through the recess in order to be able to introduce a cut. The border provides a seal relative to the article to be machined. It is thereby possible to improve the removal of machining waste.

It is provided that in an operating position of the drive motor a motor housing is fixed relative to a tool protection cap. The motor housing is fixed in the pulling position or in the pushing position on the tool protection cap.

It may additionally be provided that the at least one cutting tool is movable relative to the contacting device, so that the at least one cutting tool is movable between a retracted position relative to the contacting device and a cutting position. In the retracted position, the at least one cutting tool is positioned in a protected manner in the tool protection cap. To produce the cutting position, the cutting tool is moved relative to the tool protection cap so that it may be brought out of the tool protection cap and may act upon an object.

In particular, the at least one cutting tool is pivotable relative to the contacting device. For example, when the motor housing is fixed relative to a tool protection cap, the motor housing is pivotable relative to the contacting device.

It may be provided that a depth of cut of the at least one cutting tool is adjustable by adjusting the relative pivotability between the at least one cutting tool and the contacting device. Depending on the permitted pivotal angle, the depth of cut may then be adjusted.

In a structurally simple form of construction, a tool protection cap is supported pivotably on the contacting device. By pivoting the tool protection cap with the drive motor fixed relative to the tool protection cap, advance of the cutting tool relative to an object to be machined may be effected.

In this connection, it is advantageous when a pivot bearing for pivotably supporting a tool protection cap on the contacting device is spring-loaded. For the at least one cutting tool to disengage from the tool protection cap, an operator has to exert a force counter to the spring action. When no force and/or insufficient force is exerted, the at least one cutting tool then moves automatically back into the tool protection cap.

In accordance with the invention, a method of adjusting cut introduction options in a hand-held machine tool for introducing cuts is provided. A drive motor for at least one cutting tool is pivoted relative to a contacting device of the hand-held machine tool against an article to be machined, so that the position of a motor housing of the drive motor relative to the contacting device is varied and a pulling cutting position or pushing cutting position is adjustable.

Further advantageous embodiments of the method according to the invention have been mentioned in connection with the hand-held machine tool in accordance with the invention.

In particular, a pulling position or a pushing position of the drive motor is fixed.

The following description of preferred embodiments serves in connection with the drawings to provide a detailed explanation of the invention.

### BRIEF DESCRIPTION OF THE DRAWINGS

FIG. 1 an exploded view of an embodiment of a hand-held machine tool in accordance with the invention for introducing cuts;

FIG. 2 a side view of the hand-held machine tool according to FIG. 1 (in the assembled state) with the drive motor in a pulling position;

FIG. 3 a perspective view of the hand-held machine tool according to FIG. 2;

FIG. 4 the hand-held machine tool according to FIG. 1 in a pushing position of the drive motor;

FIG. 5 a perspective view of the hand-held machine tool according to FIG. 4;

FIG. 6 a diagrammatic view of a cutting tool in a saw notch and

FIG. 7 a side sectional view of a tool protection cap of the hand-held machine tool according to FIG. 1.

### DETAILED DESCRIPTION OF THE INVENTION

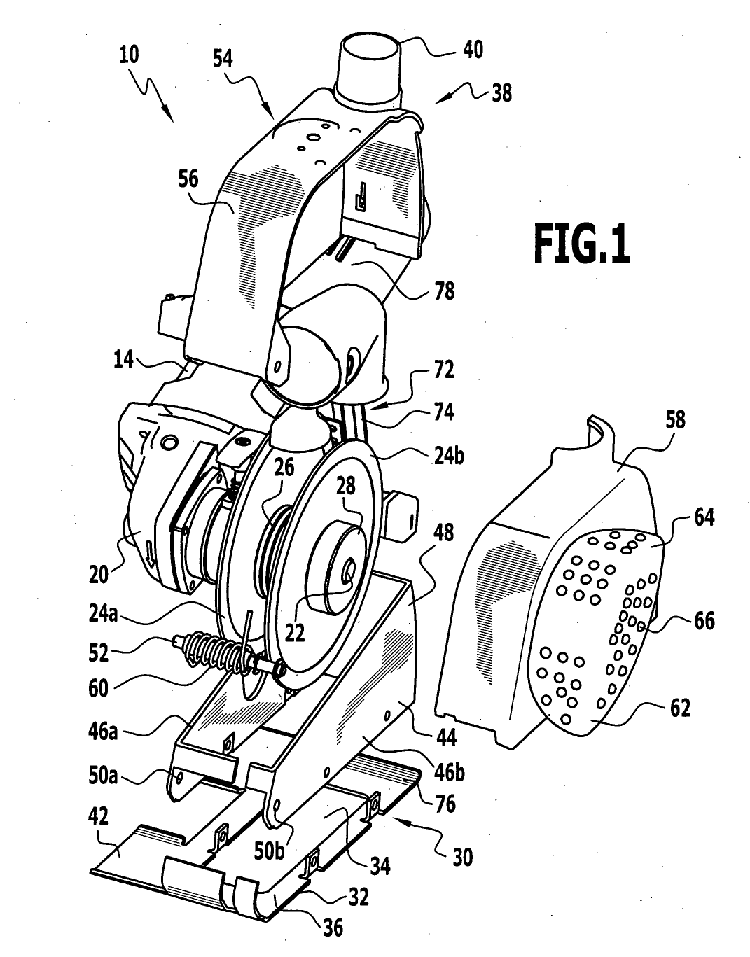

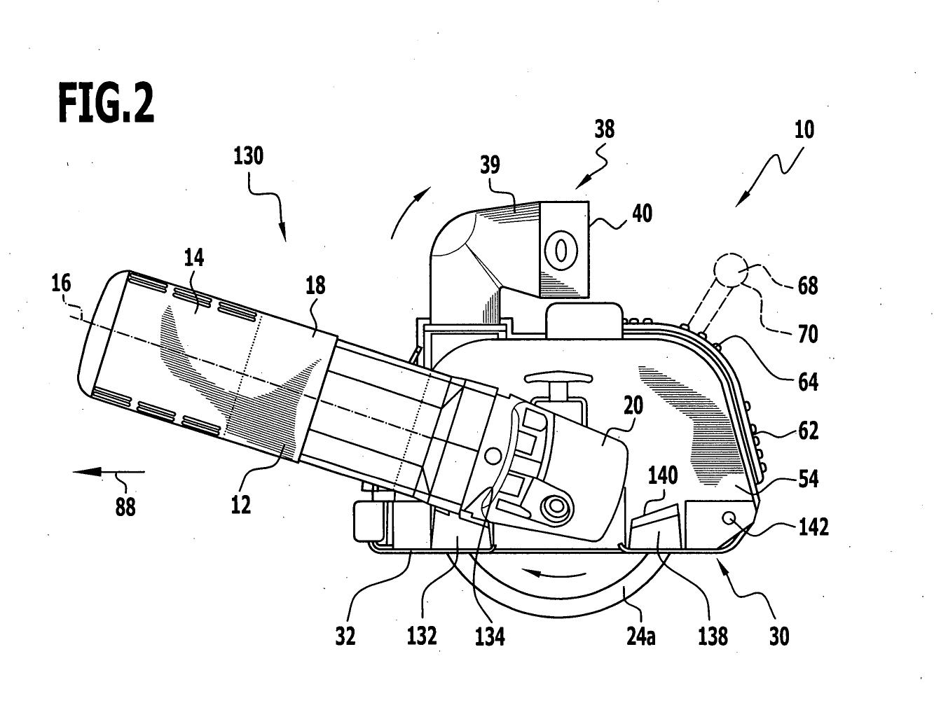

An embodiment of a machine tool in accordance with the invention, which is shown in FIG. 1 in an exploded view and in FIGS. 2 to 5 and is denoted as a whole by 10, comprises a drive motor 12, which is disposed in a motor housing 14.

The motor housing 14 extends in a longitudinal direction 16 (FIG. 2). It comprises a gripping region 18, at which an operator may hold the motor housing 14 and hence the hand-held machine tool.

On the motor housing 14 a gearhead 20 is disposed. Disposed in the gearhead 20 is a gear unit for driving a tool shaft 22. A motor shaft of the drive motor 12 is substantially parallel and/or coaxial with the longitudinal direction 16 of the motor housing 14; the tool shaft 22 is orientated substantially at right angles to the longitudinal direction 16 of the motor housing 14. The gear unit, which is in particular an angular gear, is the means of transmitting the torque from the motor shaft of the drive motor 12 to the tool shaft 22.

Seated on the tool shaft 22 are one or more tools and, in particular, one or more cutting tools. In the illustrated embodiment, a first cutting disk 24a and a second cutting disk 24b are provided as cutting tools. These cutting disks are for example diamond wheels. The two cutting disks 24a and 24b are spaced apart from one another, wherein seated between them is a spacer 26 in the form of a ring or ring packet. By means of the spacer 26 the distance between the two cutting disks 24a and 24b is adjustable.

The hand-held machine tool 10 in accordance with the invention is designed for example as a masonry wall slotter that enables the introduction of slots e.g. for cables in an article such as a wall. The distance between the two cutting disks 24a and 24b determines the slot width.

By means of one or more fixing disks 28 the cutting disks 24a and 24b are fixable on the tool shaft 22.

The hand-held machine tool 10 comprises a contacting device 30 with a substantially flat contact surface 32. By means of this contact surface 32 the hand-held machine tool 10 is positionable against, and guidable on, an object that is to be machined.

The contacting device 30 has a recess 34 in the form of a hole, which is surrounded by a border or enclosure 36; the border 36 encloses the recess 34. The cutting disks 24a, 24b are engaged through the recess 34 when an object is being machined. By means of the border 36 a machining area on the object may be sealed off. This allows an extraction of machining residues to be carried out through the recess 34.

For the extraction of machining residues, the hand-held machine tool 10 comprises a removal device 38 with an extraction elbow 39. The removal device 38 has for example a connection 40, to which a vacuum cleaner is attachable.

In the illustrated embodiment, the contacting device 30 comprises a bed plate 42 (skid plate), on which the contact surface 32 is formed. The bed plate 42 is in particular slidingly guidable over an object that is to be machined. Seated on the bed plate 42 is a holding element 44. This is fixed for example by screw-type connections on the bed plate 42. The holding element 44 comprises opposing walls 46a and 46b, which are connected by a rear wall 48.

In the vicinity of an end of the walls 46a, 46b remote from the rear wall 48 there are formed in these walls openings 50a and 50b, which are aligned flush with one another and receive a cylindrical pin 52 for forming a pivot bearing.

The walls 46a and 46b increase in height from the openings 50a, 50b towards the rear wall 48. The holding element 44 forms a cover for the tool or tools of the hand-held machine tool 10.

On the contacting device 30 and in particular on the holding element 44 a tool protection cap 54 or tool guard is pivotably supported. In the embodiment shown in FIG. 1, the tool protection cap 54 comprises a first part 56, which is held pivotably on the contacting device 30. The tool protection cap 54 further comprises a second part 58, which is fixable on the first part 56.

For machining an object, the gearhead 20 is fixed relative to the tool protection cap 54. (The drive motor 12 and therefore the gearhead 20 are pivotable relative to the contacting device 30 and hence relative to the tool protection cap 54, wherein pivoting is effected in order to adjust a machining position of the drive motor 12. During the actual machining, the drive motor 12 is fixed in terms of its pivotability relative to the tool protection cap 54. This is explained in more detail below.) The pivotability of the tool protection cap 54 relative to the contacting device 30 allows the cutting disks 24a and 24b to pivot relative to the contacting device 30. A pivot bearing is formed by means of the pin 52.

The pivot bearing in said case is spring-loaded, for example by means of a leg spring 60 seated on the pin 52, in such a way that without any application of force the tool protection cap 54 and hence the cutting disks 24a and 24b are pressed away from the contacting device 30 in such a way that the tools are seated above the bed plate 42 and hence are seated in the tool protection cap 54 and between the walls 46a, 46b and the rear wall 48.

To machine an article, the cutting disks 24a, 24b have to engage through the recess 34. For this purpose, an operator has to press the drive motor 12 in the direction of the bed plate 42 in order to pivot the drive motor 12 relative to the contacting device 30 by means of the pivot bearing formed by the pin 52. This allows the cutting disks 24a, 24b to pass through the recess 34 and act upon an article that is to be machined.

Without any exertion of force on the motor housing 14, the tools are seated in a protected manner in the tool protection cap 54.

Disposed on the tool protection cap 54 is a gripping element 62, which may be used to hold the hand-held machine tool 10. The hand-held machine tool 10 may then be held for example by holding the motor housing 14 at the gripping region 18 thereof with one hand and taking hold of the gripping element 62 on the tool protection cap 54 with the other hand.

In the embodiment shown in FIG. 1, the gripping element 62 is formed by means of a hand contact region 64. This is provided for example with pimples 66 or the like to prevent slipping.

It is alternatively or additionally possible to provide a bow-type handle 68, as indicated by dashes in FIG. 2, to allow the hand-held machine tool 10 to be held.

It is also possible for the gripping element to be formed by means of the extraction elbow 39.

The gripping element 62 is electrically insulated from metal regions of the hand-held machine tool 10 in order to protect the operator in the event of damage to a power cable (which is not shown in the drawings). This electric insulation may be effected in various ways. For example, the hand contact region 64 may be manufactured from an electrically non-conducting material. Preferably, the hand contact region 64 is so dimensioned that a hand located thereon does not touch the tool protection cap 54.

If a bow-type handle 68 is provided, a corresponding gripping element 70 of this bow-type handle is then manufactured from an electrically non-conducting material or is provided with such an electrically non-conducting material.

It may also be provided that the tool protection cap 54, on which the gripping element 62 is disposed, is manufactured from an electrically non-conducting material or is at least partially manufactured from an electrically non-conducting material. For example, the second part 58 is manufactured from an electrically non-conducting material.

It is also possible for the tool protection cap 54 to be electrically insulated from metal parts of the hand-held machine tool 10 by providing electric insulation at appropriate points.

On the contacting device 30 a guide 72 is disposed for the pivoting of the tool protection cap 54 relative to the contacting device 30. This guide comprises for example a bow 74, which is seated on a region 76 of the bed plate 42 that is situated in the vicinity of the rear wall 48 outside of an interior 78 of the tool protection cap 54 and the holding element 44.

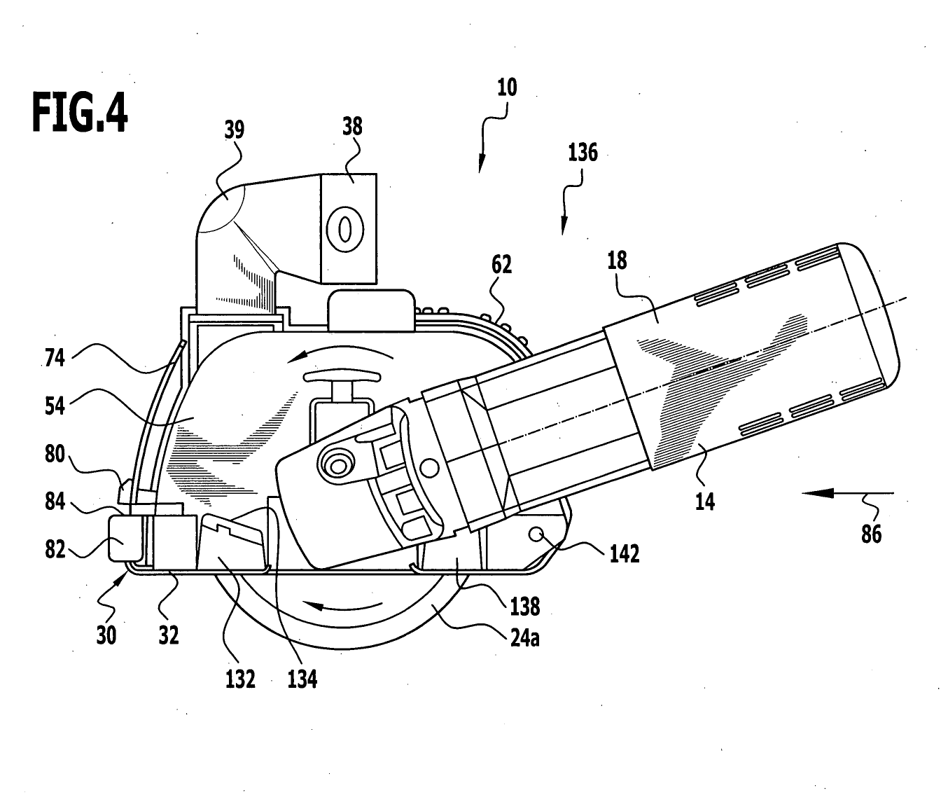

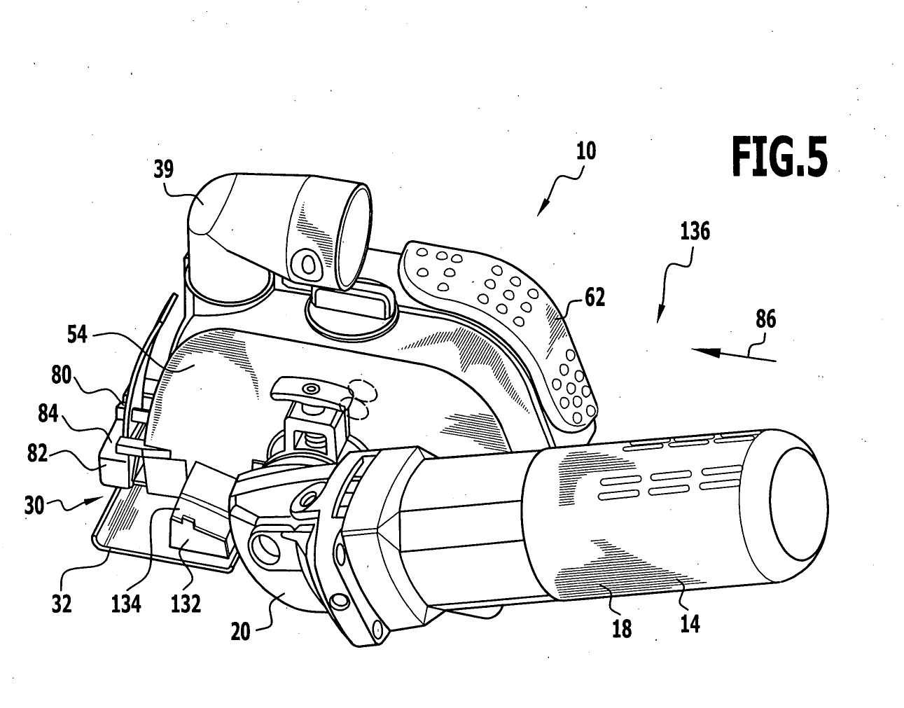

On the tool protection cap 54 a stop element 80 (FIGS. 4 and 5) is fixed, which abuts against the bow 74 and limits the opening of the tool protection cap 54.

Disposed on the region 76 of the bed plate 42 is a stopping element 82 (FIGS. 4 and 5), which provides a blocking surface 84 for the stop element 80 to prevent further pivotability in the direction of the contacting device 30.

In said case, it is in principle also possible for the stopping element 82 to be, not firmly connected to the bed plate 42, but disposed in a fixable displaceable manner on the bow 74. The position of the stopping element 82 on the bow 74 is then adjustable and so the maximum pivoting angle of the tool protection cap 54 with the drive motor 12 relative to the contacting device 30 is adjustable. Thus, in turn, the depth of cut of the cutting disks 24a, 24b in an article to be machined is adjustable.

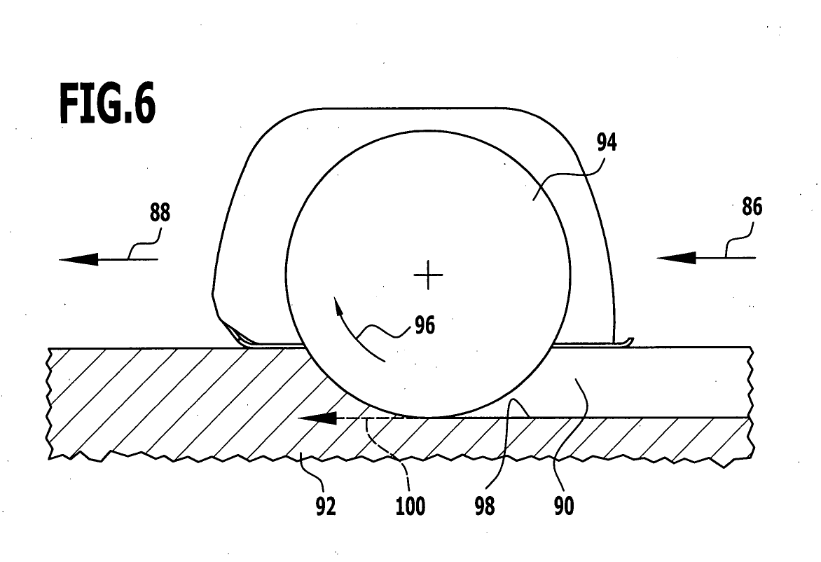

During the introduction of saw slots, it is in principle possible, as explained with reference to FIG. 6, for the hand-held machine tool to be pushed or pulled. Pushing is indicated in FIG. 6 by the arrow having the reference character 86 and pulling is indicated in FIG. 6 by the arrow having reference character 88. During pushing, the hand-held machine tool is pushed forward and, during pulling, it is pulled towards the operator.

When vertical slots are to be produced, for example in a masonry wall, pulling introduction of a cut is then selected. Pushing introduction of a cut to produce vertical slots is usually possible only with difficulty because, in addition to the feed force, gravitational force also has to be overcome. When horizontal slots are to be produced, for example in a masonry wall, pushing introduction of a cut is then selected. Pulling introduction of a cut for horizontal slots is usually possible only with great difficulty.

To produce a slot 90 in an object 92 such as a masonry wall, the tool 94 (driven via the tool shaft 22) has to be driven in such a direction of rotation 96 that at a slot base 98 a velocity vector 100 of the tool 94 and the direction of motion (the pushing direction 86 or the pulling direction 88) are substantially parallel. The velocity vector 100 and the direction of motion of the hand-held machine tool may not be antiparallel.

In accordance with the invention a hand-held machine tool is provided, which allows a switchover between pulling introduction and pushing introduction of a cut.

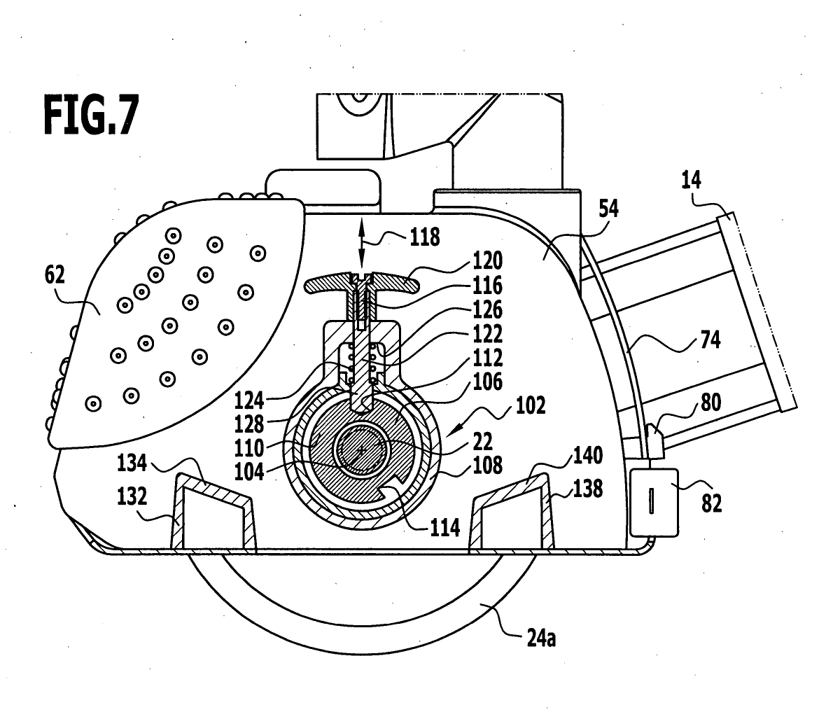

For this purpose, the motor housing 14 and hence the drive motor 12 are supported pivotably relative to the contacting device 30. For this purpose, a pivot bearing 102 is provided, which is formed on the tool protection cap 54 and in particular on the first part 56 thereof and the gearhead 20 (FIG. 7). By virtue of the pivot bearing 102 a pivotal axis 104 is provided, which is substantially coaxial with an axis of rotation of the tool shaft 22.

The pivot bearing 102 comprises for example a hollow-cylindrical shaft 106, which is connected in a rotationally fixed manner to the gearhead 20 and is therefore rotationally fixed relative to the drive motor 20 and hence the motor housing 14.

The shaft 106 extends in a shaft housing 108, which is seated in a rotationally fixed manner on the tool protection cap 54 and in particular on the first part 56 thereof facing the gearhead 20.

A slotted disk 110 is seated on the shaft 106 or such a slotted disk 110 is formed on the shaft 106 itself. The slotted disk 110 comprises a first slot 112 and a spaced-apart second slot 114.

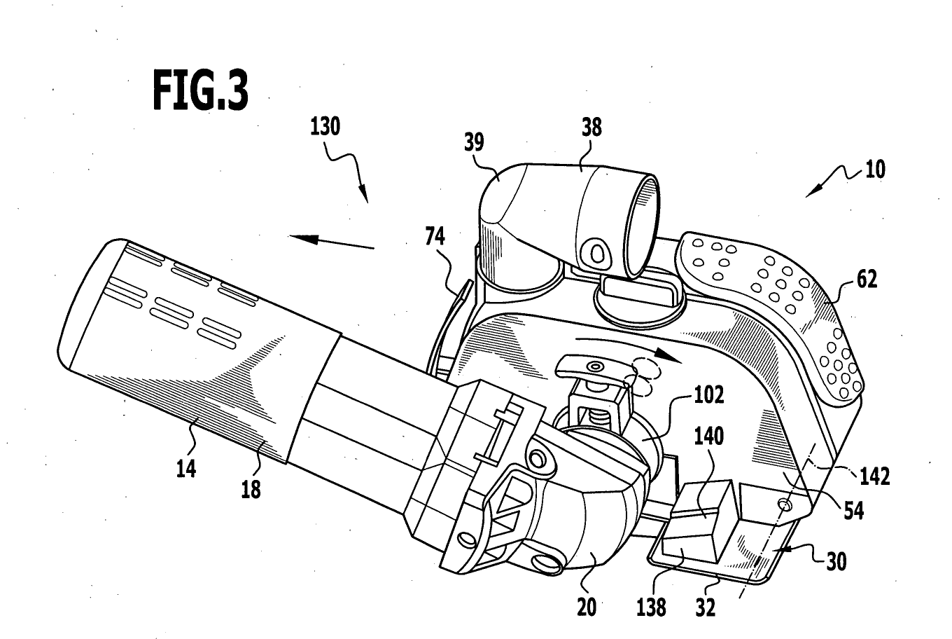

The first slot 112 defines a distinguished pivoted position of the drive motor 12 relative to the contacting device 30 that is a pushing position (FIGS. 4 and 5). The second slot 114 defines a further distinguished position of the drive motor 12 relative to the contacting device 30 that is a pulling position (FIGS. 2 and 3).

Seated on the shaft housing 108 is a locking element 116, which is displaceable in a direction 118 transversely of and in particular at right angles to the pivoting axis 104. The locking element 116 has a gripping region 120 and a pin region 122. By means of the pin region 122 the locking element 116 may engage into the first slot 112 or the second slot 114. In the engaged state of the pin region 122, the shaft 106 is locked against rotation.

The locking element 116 is spring-loaded by a spring 124. This spring is positioned between an inner side 126 of the shaft housing 108 and an engagement region 128 of the pin region 122. By means of the spring 124 the engagement region 128 is pressed away from the inner side 126 and, when the engagement region 128 lies adjacent to the first slot 112 or the second slot 114, the engagement region 128 is pressed into the corresponding slot 112 or 114.

To cancel a locking position and allow pivoting of the motor housing 14, an operator has to overcome the spring action of the spring 124 in order to be able to withdraw the engagement region 128 from the slot 112 or 114. For this purpose, an operator has to expend force and pull the locking element 116 upwards at the gripping region 120.

A first distinguished position of the drive motor 12 relative to the contacting device 30 is, as shown in FIGS. 2 and 3, a pulling position 130. In this position the locking element 116 has engaged into the second slot 114.

In the pulling position 130 the motor housing 14 is situated in a pivoted position relative to the tool protection cap 54, in which the longitudinal direction 16 is at an acute angle to the contact surface 32.

Seated on the tool protection cap 54 is a blocking element 132, which provides an inclined blocking surface 134 (relative to the contact surface 32). The motor housing 14 is positionable against this blocking surface 134; in the pulling position 130 the pivoted position of the drive motor 12 is fixed via the motor housing 14 relative to the contacting device 30 by means of the blocking element 132 and the locking element 116.

In the pulling position 130 an operator may hold the motor housing 14 at the gripping region 18 for example with his right hand and moreover take hold of the gripping element 62 on the tool protection cap 54 with his left hand. By pulling in the direction 88 a pulling cut may then be introduced into an article.

In a pushing position 136 (FIGS. 4 and 5 as well as FIG. 7), the locking element 116 has engaged into the first slot 112. The motor housing 14 is fixed in a pivoted position on the tool protection cap 54 that differs by a pivoting angle of greater than 90° from the pulling position 130.

For fixing the pushing position 136 a blocking element 138 is likewise provided, which has an inclined blocking surface 140, wherein the inclination of the blocking surface 140 is in the opposite direction to the inclination of the blocking surface 134. The blocking element 138 is likewise seated on the tool protection cap 56.

In the pushing position 136, an operator may grasp the motor housing with his left hand and hold the tool protection cap 54 with his right hand. The hand-held machine tool 10 is then pushable in direction 86 in order to be able to introduce a pushing cut into an object.

The motor housing 14 and hence the drive motor 12 have different secured pivoted positions relative to the contacting device 30 and in particular relative to the contact surface 32 depending on whether a pulling cut or a pushing cut is to be introduced. During machining of an article, the appropriate pivoted position of the motor housing 14 on the tool protection cap 54 is fixed, i.e. the locking element 116 has engaged into the first slot 112 or into the second slot 114.

For machining, the motor housing 14 is pivoted relative to the contacting device 30 in order to lift the cutting disks 24a, 24b out through the contact surface 32. This pivoting occurs about a pivotal axis that is spaced apart from, and in particular not coaxial with, the tool shaft 22.

The hand-held machine tool 10 in accordance with the invention is used as follows:

Depending on the machining application, the motor housing 14 is brought into the pulling position 130 or the pushing position 136. The pulling position is used above all to produce vertical slots and the pushing position 136 is used above all to produce horizontal slots. The pulling position 130 or the pushing position 136 is fixed.

The hand-held machine tool 10 is then positioned by the contact surface 32 on the object to be machined, such as for example a masonry wall, and switched on in order to set the cutting disks 24a, 24b in rotation. The motor housing 14 is then pivoted about a pivotal axis 142 in the direction of the contact surface 32 in order to be able to bring the cutting disks 24a, 24b into engagement with the object and in turn allow a slot 90 to be produced.

The depth of cut is adjustable by means of the position of the stopping element 82 on the bow 74.

The bed plate 42 during machining rests on the article and machining waste may be extracted through the recess 34 and the removal device 38.

In the pulling position 130 of the motor housing 14, the hand-held machine tool 10 is pulled along an article, wherein the contact surface 32 serves as a guide surface.

In the pushing position 136, the hand-held machine tool is pushed along the object, wherein the contact surface 32 serves as a guide surface.

1. Hand-held machine tool for introducing cuts, comprising
a drive motor for at least one cutting tool; and
a contacting device, by which the hand-held machine tool is adapted to contact an object to be machined and is guidable on said object;
wherein the drive motor is disposed in a lockable pivotable manner relative to the contacting device, and
wherein at least one pulling position for pulling introduction of a cut and at least one pushing position for pushing introduction of a cut is adjustable.

2. Hand-held machine tool according to claim 1, wherein the contacting device is disposed or formed on a tool protection cap.

3. Hand-held machine tool according to claim 1, wherein for the pivotability of the drive motor relative to the contacting device a pivot bearing is provided, which has a pivotal axis that is substantially coaxial with an axis of rotation of a tool shaft.

4. Hand-held machine tool according to claim 1, wherein the drive motor is supported pivotably on a tool protection cap.

5. Hand-held machine tool according to claim 1, wherein at least one gripping element is disposed or formed on a tool protection cap.

6. Hand-held machine tool according to claim 5, wherein associated with the at least one gripping element is electric insulation, which insulates the at least one gripping element electrically from metal regions of the hand-held machine tool.

7. Hand-held machine tool according to claim 5, wherein the at least one gripping element is formed by means of a hand contact region on the tool protection cap.

8. Hand-held machine tool according to claim 5, wherein the at least one gripping element is formed by means of a handle or constructed by means of an extraction elbow.

9. Hand-held machine tool according to claim 1, wherein a distinguished pulling position for the drive motor is lockable.

10. Hand-held machine tool according to claim 1, wherein a distinguished pushing position for the drive motor is lockable.

11. Hand-held machine tool according to claim 9, wherein the distinguished pulling position and a distinguished pushing position are situated apart from one another by a pivotal angle of more than 90°.

12. Hand-held machine tool according to claim 1, wherein for the drive motor a motor housing is provided, of which the operator can take hold.

13. Hand-held machine tool according to claim 1, wherein in a distinguished pulling position for the drive motor a motor housing is positioned at an acute angle to a contact surface of the contacting device.

14. Hand-held machine tool according to claim 1, wherein in a distinguished pushing position for the drive motor a motor housing is positioned at an acute angle to a contact surface of the contacting device.

15. Hand-held machine tool according to claim 1, wherein a first blocking element is provided for forming a blocking surface for a distinguished pulling position for the drive motor.

16. Hand-held machine tool according to claim 15, wherein the first blocking element has a blocking surface that is inclined relative to a contact surface of the contacting device.

17. Hand-held machine tool according to claim 1, wherein a second blocking element is provided for forming a blocking surface for a distinguished pushing position for the drive motor.

18. Hand-held machine tool according to claim 17, wherein the second blocking element has a blocking surface that is inclined relative to a contact surface of the contacting device.

19. Hand-held machine tool according to claim 1, wherein a slotted disk is provided for securing a specific pivoted position of the drive motor relative to the contacting device.

20. Hand-held machine tool according to claim 19, wherein the slotted disk has a first slot for defining a distinguished pushing position and a second slot for defining a distinguished pulling position.

21. Hand-held machine tool according to claim 19, wherein a locking element is provided, which is engageable into a slot of the slotted disk to secure a specific pivoted position.

22. Hand-held machine tool according to claim 21, wherein the locking element is spring-loaded.

23. Hand-held machine tool according to claim 19, wherein the slotted disk is disposed between the drive motor and a tool protection cap.

24. Hand-held machine tool according to claim 1, wherein a removal device for machining waste is provided.

25. Hand-held machine tool according to claim 1, wherein the contacting device has a recess surrounded by a border for the at least one cutting tool.

26. Hand-held machine tool according to claim 1, wherein in an operating position of the drive motor the drive motor is fixed relative to a tool protection cap.

27. Hand-held machine tool according to claim 1, wherein the at least one cutting tool is movable relative to the contacting device in such a way that the at least one cutting tool is movable between a retracted position relative to the contacting device and a cutting position.

28. Hand-held machine tool according to claim 27, wherein at least one cutting tool is pivotable relative to the contacting device.

29. Hand-held machine tool according to claim 27, wherein a depth of cut of the least one cutting tool is adjustable by adjusting the relative pivotability between the at least one cutting tool and the contacting device.

30. Hand-held machine tool according to claim 26, wherein a tool protection cap is supported pivotably on the contacting device.

31. Hand-held machine tool according to claim 26, wherein a pivot bearing for pivotably supporting a tool protection cap on the contacting device is spring-loaded.

32. Method of adjusting cut introduction options in a hand-held machine tool for introducing cuts, comprising:
pivoting a drive motor for at least one cutting tool relative to a contacting device of the hand-held machine tool against an object to be machined, so that the position of a motor housing of the drive motor relative to the contacting device is varied and a pulling cutting position or pushing cutting position is adjustable.

33. Method according to claim 32, wherein a pulling cutting position of the drive motor is fixed.

34. Method according to claim 32, wherein a pushing cutting position of the drive motor is fixed.
